(19) United States
(12) Patent Application Publication
(10) Pub. No.: US 2019/0011657 A1
(43) Pub. Date: Jan. 10, 2019

(54) MECHANICAL FUSE FOR USE WITH OVERHEAD TELECOMMUNICATIONS CABLE

(71) Applicant: AFL GLOBAL, Swindon, Wiltshire (GB)

(72) Inventors: James C. BAKER, Burford, Oxon (GB); Mark NAYLOR, Swindon, Wiltshire (GB)

(21) Appl. No.: 16/065,821

(22) PCT Filed: Dec. 23, 2016
(86) PCT No.: PCT/GB2016/054073

§ 371 Date: Jun. 25, 2018

(30) Foreign Application Priority Data
Dec. 23, 2015 (GB) 1522823.2

(51) Int. Cl. G02B 6/48; G02B 6/44

(52) U.S. Cl. CPC G02B 6/48; G02B 6/4439

(57) ABSTRACT

A mechanical fuse (100), (500) for an ADSS cable comprises a continuous length of ADSS cable, one or more anchors (15), (520), (530) for supporting the ADSS cable relative to a (pylon 7), and a knife, pin or the like (7), (630) which can kink, bend and/or cut the ADSS cable in a breaking region. When a load in excess of a predetermined amount is applied to the ADSS cable, for example when the ADSS cable is snagged by a vehicle, the mechanical (fuse 100), (500) breaks or separates causing the pin or knife ((7), 630) to facilitate breaking of the ADSS cable in the breaking region. A method of attaching an ADSS cable to a support (7) is also disclosed.

### FIELD OF THE INVENTION

This invention relates to a mechanical fuse for an overhead telecommunications cable, and to a method of attaching a telecommunications cable to a support structure such as an electricity pole or pylon.

### BACKGROUND TO THE INVENTION

FIG. 1 shows, schematically, a pair of support structures 7—such as towers, pylons/poles—supporting overhead power lines 9 on top of horizontal arms 8 having insulating stand offs.

It is known to suspend optical fibre telecommunications cable 10 containing no metallic wires, such as All Dielectric Self Supporting (ADSS) cable or cable with semi-conducting jackets, between these support structures 7. For simplicity we shall hereafter refer to such cables as ADSS cables. Typically, the telecommunications cable 10 is mounted from the support structures 7, below the electrical power transmission lines 9. The telecommunications cable 10 is a self-supporting cable that therefore comprises high strength components to ensure that the cable 10 does not break when it is subject to large tensile loads.

Suspending the telecommunications cable 10 from the same towers and poles 7 as electric power transmission lines 9 allows the telecommunications cable 10 to be installed by utilising existing infrastructure. However, the low mounting of the telecommunications cable 10 can cause a problem when the cable 10 spans, for example, a road where vehicles or other machinery attempting to pass under the cable 10 may snag the cable. When the cable 10 is snagged in this fashion, the cable can be subjected to a tensile load much higher than the maximum working load i.e. the load due to the tension in the cable plus the maximum extra load due to worst case environmental conditions (e.g. due to wind). Since the telecommunications cable 10 is itself formed of high strength components, even the application of a large tensile load to the cable, via such a snagging event, will not cause the cable to snap. Instead, the tensile load is transferred through the cable 10 to the support structures 9. This in turn can lead to the breakage or collapse of the supports 9.

Because the cable 10 is typically attached to multiple supports 9, the transfer of the additional tensile load through the cable 10 can result in a ‘domino effect’ whereby multiple supports 9 in the vicinity of the breakage or collapse location are pulled down together.

### SUMMARY OF INVENTION

The present invention seeks to address this problem.

According to a first aspect of the present invention, there is provided a mechanical fuse in accordance with claim 1.

The invention also extends to a mechanical fuse in accordance with claim 16.

A method of attaching a self-supporting telecommunications cable to a support is also provided, in accordance with claim 21.

Aspects of the invention thus provide for a device and method that preferentially result in breakage of the telecommunications cable, rather than the pulling down of the support(s), when the cable is placed under an excessive load, e.g. when snagged by a vehicle. A mechanical fuse is formed by a continuous length of ADSS cable, an anchor with a predetermined breaking strength, and a means for deforming or kinking the ADSS cable when an excessive load (such as a vehicle snagged upon the cable) is applied to the anchor so that the ADSS cable then is caused to break at a breaking region.

The ADSS cable may include a region of mechanical weakness to facilitate the preferential breaking of the cable. One optional way of achieving that is by removing an external cladding or armour of the ADSS cable over a part of the cable. In that case, in order to protect the region of mechanical weakness from the environment, a weatherproof housing may be provided inside of which the region of mechanical weakness is located.

The tension in the telecommunications cable may be supported by anchors. These may, in a most preferred embodiment, be attached to the overhead power line support(s) at a first end, and grip the telecommunications cable at the other second end thereof, adjacent to the support. In this manner, the tension in the (relatively long span of telecommunications cable) between adjacent overhead power line supports is carried by the anchors, so that, across a particular overhead power line support, only the weight of the (relatively short length of) telecommunications cable across the support, between the first and second anchors on that support, needs to be carried. Then, when the telecommunications cable between adjacent supports is snagged, the anchor may be specifically configured either to be broken, or to come away from the support. At this point, the tension in the span of the telecommunications cable between two adjacent supports (and also any force generated by the vehicle that has snagged the cable) will be brought to bear on the region of mechanical weakness, resulting, by design, in the cable breaking at that point, rather than the support.

In alternative embodiments, the anchors may be mounted between the housing and the cable (rather than between the support and the cable). In that case, the housing is preferably itself securely mounted to the support, so that the support indirectly takes the tension in the span of cable between adjacent supports, via the housing and anchors.

In still further embodiments, the anchors form a part of the housing itself. For example, a weatherproof feed through or gland for the telecommunications cable could also act as an anchor to take the tension in the cable span between adjacent supports, so that tension in the cable within the housing (i.e., between an “input side” feedthrough and an “output side” feedthrough) is relieved until an excess load is applied to the cable spanning between adjacent supports is applied. At that point, again, the feedthroughs, acting also as anchors, may be designed to break or release the cable there, resulting in the applied load (plus the tension in the cable span between adjacent supports) being transferred to the section of cable inside the housing, in which the region of mechanical weakness is formed, leading to breakage of the cable there, rather than damage to the support itself.

To assist with breakage of the cable, a pin, peg, knife edge or other severing assistance member may be provided. Preferably this is formed adjacent to the region of mechanical weakness. If a housing is present, for example, it may be formed within, and as a fixed part of, the housing. When the anchors break or release the telecommunication cable, as a result of the latter being snagged by a vehicle, at least some of the tension in the cable span between adjacent supports, plus at least some of the additional load due to the snagging, is transferred to the relatively short length of telecommunications cable that, ordinarily, is under a lower tension/load. This may cause that short length of cable to become, briefly, taughter, causing the region of mechanical weakness to urge against the peg, knife edge or the like, whereupon it may break or may be further weakened so much that it is easily torn apart by the load.

In accordance with another aspect of the invention, there is provided a mechanical fuse for an all dielectric self supporting (ADSS) telecommunications cable, comprising a continuous length of ADSS cable, the ADSS cable having a region of mechanical weakness formed therein; an anchor to support the continuous length of ADSS cable relative to a cable support, the anchor having a predetermined breaking strength; and a means for deforming or kinking the ADSS cable at the region of mechanical weakness, when a load in excess of the predetermined breaking strength of the anchor is applied thereto, so that the ADSS cable is caused to break at that region of mechanical weakness.

Still another aspect of the invention provides for a method of attaching an all dielectric self supporting (ADSS) telecommunications cable to a support, comprising: (a) attaching the ADSS cable to an anchor point directly or indirectly supported by the support, so as to support the tension in a first section of the ADSS cable, on a first side of the anchor point, the ADSS cable being attached to the anchor point via a frangible connection; and (b) forming a region of weakness in the ADSS cable, in a second section thereof, which is on a second side of the anchor point, the second section of the ADSS cable being at least partially relieved of tension; wherein application of a load in excess of a predetermined amount results in breakage of the frangible connection, so that the second section then comes under increased tension which results in breakage of the ADSS cable at the region of weakness.

Various other advantageous features of embodiments of the present invention will become apparent upon review of the following description and drawings, and also in the accompanying dependent claims.

### BRIEF DESCRIPTION OF DRAWINGS

In order that the invention can be more readily understood, reference will now be made, by way of example only, to the accompanying drawings in which:

FIG. 1 shows, in schematic perspective view, a plurality of overhead power line support structures carrying overhead power lines and a telecommunications cable, in accordance with the prior art.

FIG. 2 shows, in schematic side view, a pair of overhead power line support structures carrying overhead power lines and a telecommunications cable, the telecommunications cable being attached to one of the support structures using a mechanical fuse in accordance with a first embodiment of the present invention.

FIG. 3 shows a side sectional view of a part of the mechanical fuse of FIG. 2.

FIG. 4 shows a cross section view of a first example of the telecommunications cable of FIGS. 2, 3, 8 and 9;

FIGS. 5a and 5b show a part of the anchors of FIG. 3 in, respectively, a first, unwound state, and a second, wound state around the telecommunications cable; and

FIG. 6 shows a side view of an embodiment of cable anchors for the mechanical fuse of FIG. 2.

FIG. 7 shows a system of three pulleys that can be used to install a telecommunications cable with a mechanical fuse such as the one depicted in FIGS. 2, 3 and 6;

FIG. 8 shows a side sectional view of a mechanical fuse in accordance with a second embodiment of the present invention;

FIG. 9 shows a top sectional view of a part of the mechanical fuse of FIG. 8; and

FIG. 10 shows a second example of the telecommunications cable of FIGS. 2, 3, 8 and 9.

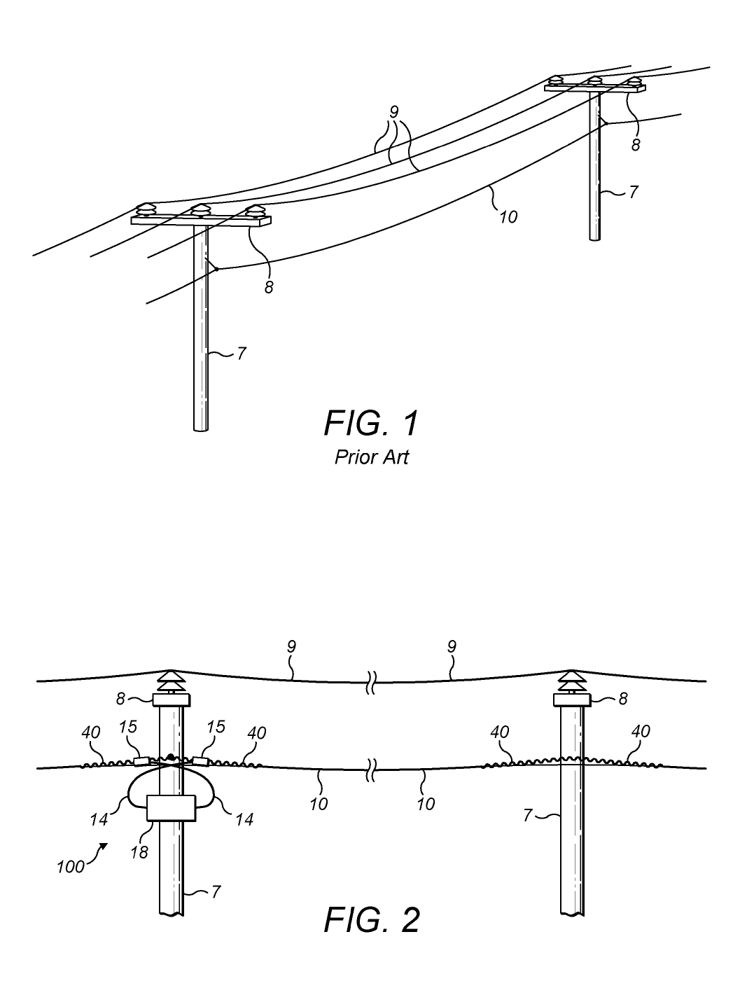

### DETAILED DESCRIPTION OF THE INVENTION

FIG. 2 shows, in schematic side view, the tops of two adjacent support structures 7 supporting overhead power lines 9 on top of horizontal arms 8 with insulating stand offs, as has been described in the background section above in respect of the prior art. Connected between the support structures 7 is telecommunications cable 10 such as an ADSS cable.

As with the prior art, the ADSS cable is preferably mounted below the overhead power lines 9.

In the arrangement of FIG. 2, however, the ADSS cable 10 is connected to one of the support structures 7 using a mechanical fuse which is shown in FIG. 2 generally at reference numeral 100. The mechanical fuse 100, in the embodiment shown in FIG. 2, comprises first and second anchors 15 which connect the ADSS cable 10 to the support 7, a looped length of ADSS cable 14 between the first and second anchors 15 and a weatherproof housing 18. The length of ADSS cable 14 between the anchors 15 passes through the weatherproof housing 18. Inside the housing 18, the length of ADSS cable 14 has a point or region of mechanical weakness formed therein. The reasons for this will be explained below.

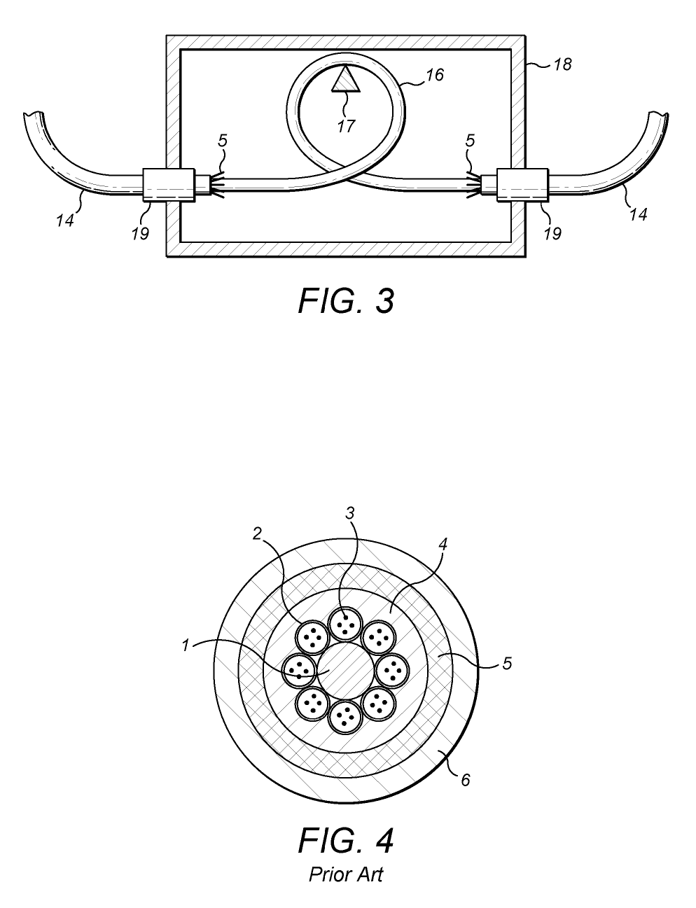

FIG. 3 shows a close-up, sectional view through the housing 18 of the mechanical fuse 100 shown in FIG. 2. As may be seen in FIG. 3, the length of ADSS cable 14 between the two anchors 15 (FIG. 2) passes through the housing 18. First and second feedthroughs or cable glands 19 are provided in the walls of the waterproof housing 18 so as to provide a weather-tight seal against the length of ADSS cable 14 as it enters and exits the weatherproof housing 18.

Inside the housing 18, the outer protective layers, shown generally by reference numeral 5 in FIG. 3, of the ADSS cable are removed. Outer layers 5 provides mechanical strength to the ADSS cable so that their removal, inside the housing 18, presents a short length of ADSS cable 16, inside the housing 18, which is relatively mechanically weaker than the rest of the loop of ADSS cable 14 between the anchors 15, and likewise weaker than the remainder of the ADSS cable 10 spanning the supports 7. The removal of outer sheath 6 may also occur in order to allow access to outer layers 5. Outer sheath 6 provides weather resistance to the ADSS cable.

Also inside the housing 18 is provided a pin 17 which, preferably, has a sharp edge such as a knife edge. The pin is formed as part of, or attached to the body of, the housing 18 and is adjacent to the loop within the mechanically weaker length of ADSS cable inside the housing 18.

FIG. 4 shows, in schematic cross-section, the construction of a typical ADSS cable 10. Standard ADSS cable comprises a central strength member (csm) 1 around which is formed, generally concentrically, a plurality of tubes 2. Each tube contains fibre optics 3 for telecommunications.

The tubes 2 are themselves protected within an inner sheath 4 and form the inner core of the ADSS cable 2.

Surrounding the inner core of the ADSS cable formed by the csm 1, the tubes 2 containing the fibre optic cables, and the outer sheath 4, is a first strength member 5 formed of aramid fibre yarn.

On top of the aramid fibre yarns is formed an outer sheath 6 which protects the ADSS cable from ultraviolet light and, where applicable, from damage due to leakage current, for example.

As show in FIG. 3, the outer layers 5 and 6 of the ADSS are removed to provide the regional of mechanical weakness in the mechanical fuse. Layer 5 is the strength providing layer and removing this layer weakens the ADSS cable. Layer 6 is an outer sheath which may be removed before strength providing layer 5 in order to allow access to the strength proving layer 5.

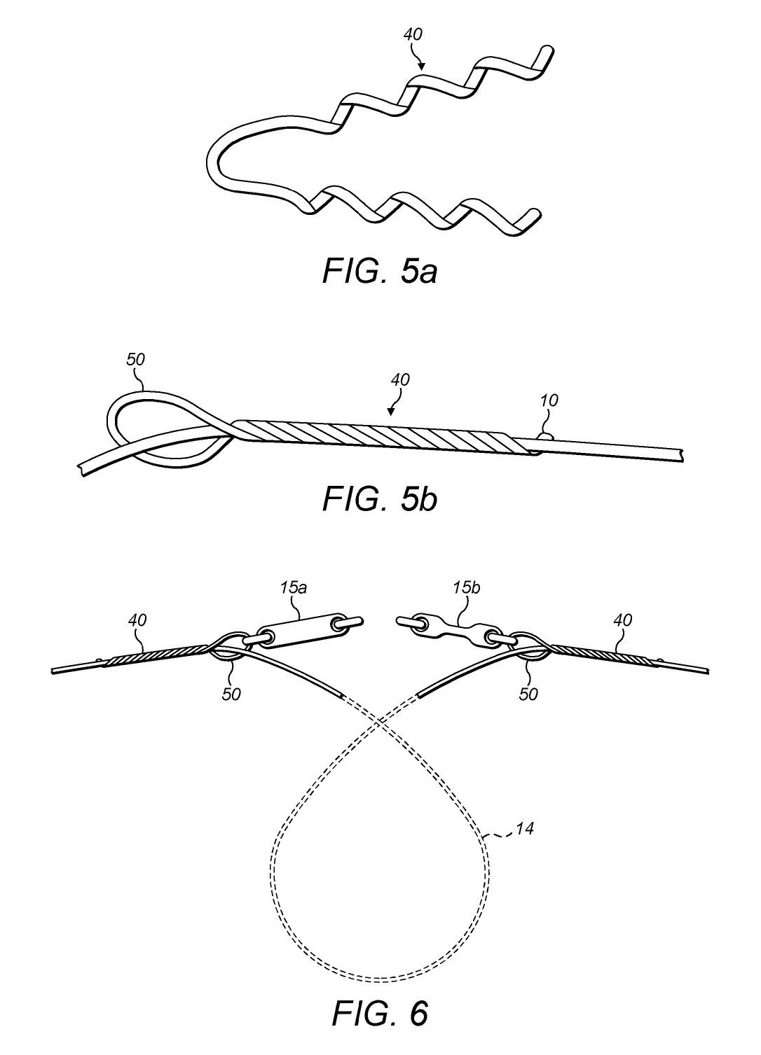

Turning now to FIGS. 5a and 5b, a so-called dead-end connector 40 is shown, for attaching the ADSS cable 10 to a fixed mounting point such as the support 7. The dead-end connector 40 is initially formed as a generally V-shaped piece of high tensile strength material and is twisted around the ADSS cable 10 (FIG. 5b). As will be seen, once wrapped around the ADSS cable 10, the dead-end connector 40 terminates in a loop 50, whose purpose will be explained in connection with FIG. 6 below.

The dead-end connector 40 is positioned upon the ADSS cable 10 at a location where the ADSS cable can be connected to a support 7 with the loop 50 of the dead-end connector 40.

Referring now to FIG. 6, one suitable method for attaching the ADSS cable 10 to the support 7 is shown. In FIG. 6, the support itself is not shown for the sake of clarity. FIG. 6 shows a mechanical fuse comprising a first anchor and a second anchor and a looped length of ADSS cable 14 between the first anchor and the second anchor.

The ADSS cable 10 may be connected to the support 7 using either a fused coupling 15b or an unfused coupling 15a. The fused coupling 15b hooks or clips onto the loop 50 of the dead-end connector 40 at a first end, and is attached to the support 7 using a suitable connection. For example, in the case of a wooden pole, a hole may be drilled in the pole to accept an eye bolt or a hole may be drilled (or simply be present) in the metal cross arm. A shackle can then be fitted to secure the ADSS cable to the pole structure. The fused coupling 15b has a waisted portion. The unfused coupling 15a likewise connects at a first end to the loop 50 of the dead-end connector 40 and, at its other end, to the port 7 using a suitable arrangement as described above.

The waist in the fused coupling 15b results in an ultimate tensile strength thereof which is sufficient to support the maximum working tension of the ADSS cable 10 between adjacent supports 7, yet will break when a higher load, such as when an item of farm machinery snags the ADSS cable 10. The unfused coupling 15a, by contrast, has a higher ultimate tensile strength than the fused coupling 15b. The reasons for this will be explained below.

Having described the preferred arrangement of the mechanical fuse embodying the present invention, one suitable method of installation will now be described.

Typically, ADSS cable 10 is installed in situ across multiple supports 7 (often over many kilometres) as a single, continuous length of cable. The cable is typically carried on a drum and is drawn off that as the cable is deployed.

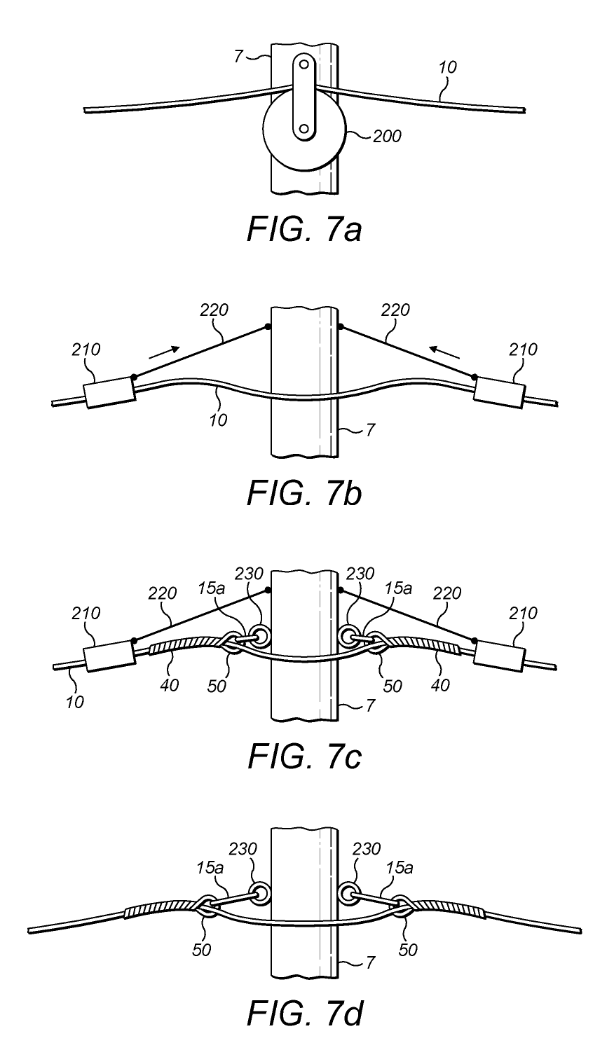

FIGS. 7a-7d show one exemplary method for installation of ADSS cable 10 at a support 7. By way of general introduction, the ADSS cable is passed along a line of supports using temporary installation pulleys mounted upon each support. The ADSS cable must, once in situ, be sagged i.e. tensioned to a predetermined sag. While this tension is maintained, the couplings (fused or unfused) are fitted and the temporary installation pulleys are then removed.

There are three types of support 7: a suspension pole, a section pole and an angle pole. A suspension pole simply holds up the conductors which therefore pass from side-to-side in a straight line. A section pole is also used in a straight line but it is designed to withstand a collapse of the line on one side. It therefore limits the ‘domino’ effect should there be a failure in either adjacent section. An angle pole is used where the line changes direction and, apart from the change in direction, resembles a section pole. Section poles are always used on either side of critical crossings e.g. road crossings, so a conductor breakage in either of the adjacent sections does not present a hazard to the crossing itself. In contrast, the present invention deals with a problem of a snagged ADSS cable (installed below the conductors) within the span over the critical crossing.

To return to the ADSS cable installation, and referring first to FIG. 7a, a temporary pulley 200 is installed at the support 7 to facilitate the deployment of the ADSS cable 10. The ADSS cable 10 is then drawn over the temporary pulley 200 and along to the next support (not shown in FIGS. 7a-7d).

It is known, for example at angle poles, to fit temporary clamps, called come-along clamps, which can be drawn towards the pole using a ratchet arrangement, to provide slack so the ADSS cable can follow the angle of the line without being subject to the sagging tension which might result in kinking. Such an arrangement can advantageously be employed in embodiments of the present invention as well. This is shown in FIG. 7b, where a pair of come along clamps 210 are shown clamped to the ADSS cable 10 and also temporarily tethered to the support 7 via come along clamp ratchets shown highly schematically at 220.

Once the come along clamps 210 have been positioned on the ADSS cable 10 and clamped in place, and the ratchets have been connected to the support 7, the dead end connectors 40 (FIG. 6) can be wrapped around the ADSS cable 10, along with the fused coupling 15b, or the unfused coupling 15a, as appropriate, in accordance with the technique described above in respect of FIG. 6. In particular, when the ADSS cable 10 spans a location where it is considered that snagging is unlikely, unfused couplings 15a can be employed on both sides of the support 7. This is the scenario illustrated in FIGS. 7a-7d, wherein the support 7 is located away from a region of snagging concern and so employs two unfused couplings 15a.

Coupling rings 230 are then also permanently affixed to the support 7, to hold the dead end connectors 40 via the unfused couplings 15a.

Once the coupling rings 230, dead end connectors 40 and couplings 15a have been affixed in place, the ratchets 220 can be operated to draw the come along clamps 210 towards the support 7. Once the couplings 15a are close enough to the coupling rings 230, they can be clipped or otherwise connected together. At this point, the span of the ADSS cable 10 between adjacent supports 7 is held under tension by the tension in the cable 10 suspended between those adjacent supports 7, with a connection to opposed sides of a given support 7. This is shown in FIG. 7c (prior to removal of the come along clamps 210 and ratchets 220), and in FIG. 7d (following removal of the come along clamps 210 and ratchets 220). Between the two dead end connectors, that is, spanning the support 7, it will be noted that the ADSS cable 10 is relatively slack.

The method of installation shown in FIGS. 7a-7d does not employ the mechanical fuse of FIGS. 2, 3 and 6, since the support 7 in those figures is not adjacent to a region where snagging may occur. When, however, the ADSS cable 10 reaches a support 7 adjacent to a location of concern, such as, for example, the entrance to a field, a gate or the like, then the mechanical fuse 100 embodying the present invention may be employed as part of the installation at that support 7. In particular, with reference to the description of FIGS. 7a-7d above, in the case where the mechanical fuse 100 is to be included, the ADSS cable 10 spanning the gap between a nearest support and the support 7 to which the mechanical fuse 100 is to be attached is, once again, provided with a dead-end connector 40 at a location on the ADSS cable 10 adjacent to where it will be attached to the support 7. The anchor 15 which connects the ADSS cable 10 to the support 7 on the first side of the support, away from the danger area, may be of the unfused coupling type 15a. On the other side of the support 7, facing the location of concern, however, a fused coupling 15b might instead be employed.

In this case, the length of slack ADSS cable 10 hanging between the two couplings 15 is chosen to be longer than the short length of slack shown in FIGS. 7a-7d, and is instead long enough to form a loop as shown and described above in connection with FIGS. 3 and 6. That loop of slack ADSS cable 10 can then be formed with an area, point or region of weakness as previously described, along with a means for kinking or deforming the ADSS cable 10 at that point or region of weakness, so that, when a snagging event occurs, the ADSS cable 10 is preferentially broken at that point of weakness. Optionally, a housing 18 may be provided around the region of weakness so as to provide ambient protection, with a pin 17 formed in the housing adjacent to the region of weakness to act as the means for kinking or deforming the ADSS cable 10, as seen in FIG. 3. Once the thus region of weakness 16 has been formed, the housing 18 may be sealed.

The slack cable 14 may be provided by using the come-along clamps as described above or it may also be provided by using an arrangement of three pulleys 60, 61 and 62 instead of the usual single pulley as shown in FIG. 7a. The central pulley 61 is off-set to provide the slack 14 between the in-line pulleys 60 and 62. Of course in this case the come-along clamps must be fitted and take up the cable tension before the arrangement of pulleys can be removed.

The operation of the mechanical fuse will now be described. Under normal conditions, the tensile strength of the components in the mechanical fuse are such as to allow the ADSS cable 10 to be carried between the multiple supports without breaking. Such normal conditions will, of course, include periods of strong wind, snow and the like. Determination of an optimal tensile strength for the various components can be calculated or determined empirically so as to provide sufficient strength to avoid unwanted failure of the system, whilst ensuring preferential breaking of the cable when necessary as a consequence of an abnormally high load (i.e. a load that exceeds the maximum working tension) such as when the ADSS cable is snagged by an item of farm machinery or the like.

In that normal condition, then, the anchors 15 take the strain of the ADSS cable 10 as it spans between adjacent supports. On the other side of the anchors 15, however, on a particular support 7, the ADSS cable 10 is under a relatively lower tension since only the weight of the relatively short length of ADSS cable traversing a support is present.

It is this relatively lower tension in the loop of ADSS cable 14 between the anchors 15 on a particular support that allows the region of weakness 16 in the ADSS cable 10 to be formed, without the cable itself then breaking under normal loads. However, when an abnormal load is applied to the ADSS cable 10 firstly the fused coupling 15b is caused to break. At this point, the tension in the ADSS cable 10 across the span between the support 7 and its neighbour transfers to the loop of ADSS cable 14, along, of course, with any additional load applied by the vehicle or other source of abnormal load. This additional tension in the loop of ADSS cable 14 causes it to break at the region of mechanical weakness 16 in the ADSS cable. Severing of the ADSS cable 10 at the mechanical fuse 100 then results in the now two separated ends of the ADSS cable 10 falling to the ground without the support 7 or the overhead power lines 9 coming under excessive load.

The pin 17 acts to assist in the breaking of the ADSS cable at the region of weakness 16. As the tension in the ADSS cable spanning between adjacent supports 7 is transferred to the loop 14 of ADSS cable, it causes the region of weakness itself to tighten. This in turn urges the loop (FIG. 3) inside the housing to be pulled against the pin 17 which helps with breakage of the ADSS cable 10.

In this manner, then, a continuous length of ADSS cable can be installed across long distances without the need for splicing, but with an in-built mechanical fuse to protect against subsequent abnormal loads.

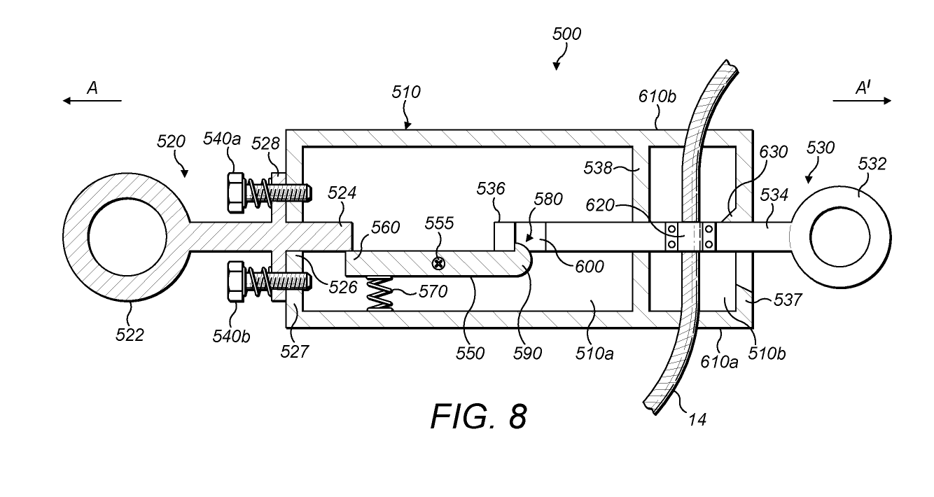

FIG. 8 shows an alternative arrangement for a mechanical fuse 500 which further exemplifies the present invention.

The mechanical fuse 500 of FIG. 8 comprises a housing 510 having a first housing portion 510a and a second, adjacent housing section 510b. A first eyelet 520 has a ring 522 for connecting to the support structure 7 (FIG. 2) and an integral shaft 524 that extends through an aperture 526 in an a first end wall 527 of the first housing portion 510a. A flange 528 extends from the shaft 524 of the first eyelet 520 and, in normal use, the flange 528 seats flat against the outside of the first end wall 527 of the first housing portion 510a.

The first eyelet 520 is mounted upon the first end wall 527 of the first housing portion 510a through the use of first and second spring loaded bolts 540a, 540b. Each spring loaded bolt passes through the flange 528 and the first end wall 527 of the first housing portion 510a such that the longitudinal axis of each spring loaded bolt 540a, 540b is parallel with the longitudinal axis of the shaft 524 of the first eyelet 520.

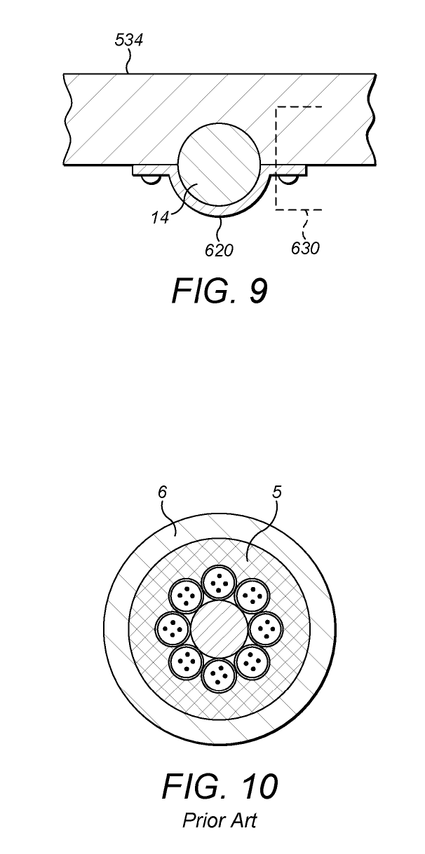

The springs that form a part of the spring loaded bolts 540a, 540b that mount the first eyelet 520 to the housing 510 are chosen so as to have known compressive characteristics. This allows the mechanical fuse to move from its “set” position (FIG. 8) into an “unset” position where the arm 550 and the shaft 534 of the second eyelet are not engaged, when a predetermined load is applied to the ADSS cable 10 (FIG. 2) that is supported by the mechanical fuse 500 of FIGS. 8 and 9. The manner in which this happens will be explained below.

Within the first portion 510a of the housing 510 is a pivotable arm 550. The pivotable arm 550 is mounted upon a central pivot 555 such as a screw or rivet. The arm 550 has a first end 560 which is biased by a spring 570 against the end of the shaft 524 of the first eyelet 520 which extends through the first end wall 527 of the first housing portion 510a of the housing 510. At a second, opposite end 580 of the pivotable arm 550 is a pawl 590.

A second eyelet 530 also comprises a ring 532 and a shaft 534. The shaft 534 extends from the ring 532 and through a second end wall 537 of the second housing portion 510b, the first and second end walls 527, 537 being at opposite ends of the housing 510. The shaft 534 of the second eyelet 530 extends generally along a common axis that also passes through the shaft 524 of the first eyelet 520. The shaft 534 also extends through a common wall 538 separating the first and second housing portions 510a, 510b as far as the second end 580 of the pivotable arm 550.

An end 536 of the shaft 534 of the second eyelet 530, distal from the ring 532 thereof, includes a detent 600 which cooperates with the pawl 590 of the pivotable arm 550. In that manner, in the set position of the mechanical fuse 500, there is a mechanical connection between the first and second eyelets 520, 530 that prevents them from moving apart from each other. Each shaft 524, 534 is, however, slidably moveable through the apertures in the walls of the first and second housing portions 510a, 510b (and the shaft 534 of the second eyelet 530 is also slideably moveable through the aperture in the common wall 538) when the pawl 590 of the arm 550 and the detent 600 in the shaft 534 of the second eyelet 530 are in the unset position and not mutually engaged.

ADSS cable 14 passes transversely through the second housing portion 510b. In particular, the ADSS cable 14 enters the second housing portion 510b through an aperture in a first side wall 610a of the second housing portion 510b. The first side wall 610a is perpendicular to the second end wall 537 of the second housing portion 510b. The ADSS cable 14 extends transversely across the inside of the second housing portion 510b towards another aperture in a second side wall 610b, generally parallel with the first side wall 610a, of the second housing portion 510b.

Where the ADSS cable 14 intersects the shaft 534 of the second eyelet 530, it is attached thereto by means of a cable clamp 620. FIG. 9 is a sectional view through a part of the shaft 534 of the second eyelet 530, where the ADSS cable 14 intersects the shaft 534, which further illustrates the means by which, in this example, the ADSS cable 14 and the shaft 534 of the second eyelet 530 are connected together.

As may be seen from FIG. 8, and in dotted line in FIG. 9, a guillotine or knife edge 630 is positioned in fixed location adjacent to the ADSS cable 14 where it is attached to the shaft 534 using the cable clamp 620.

The mechanical fuse of FIGS. 8 and 9 operates as follows. In normal operation, the spring constant/compression characteristics of the springs that form part of the spring loaded bolts 540a, 540b is sufficient to ensure that the flange 526 of the first eyelet 520 is compressed against the outside of the first end wall 527 of the first portion 510a of the housing 510. This maintains the pawl 590 in engagement with the detent 600 so that the first and second eyelets 520, 530 are maintained in a first position relative to each other as shown in FIG. 8.

When a load in excess of the spring constant of the springs in the spring loaded bolts 540a, 540b—for example, 400 kg—is applied to the ADSS cable 10 (not shown in FIG. 8), however, the flange 528 and the shaft 524 of the first eyelet 520 each move backwards, ie away from the first end wall 527 of the first housing portion 510a (in a leftward direction indicated by the arrow A in FIG. 8). This results in the end of the shaft 524 of the first eyelet 520 releasing the first end 560 of the pivotable arm 550. Because that first end 560 of the pivotable arm 550 is biased by the spring 570, the pivotable arm is forced to rotate around the central pivot 55 so that the first end 560 of the arm 550 moves upwards whilst the pawl 590 simultaneously moves downwards and out of engagement with the detent 600 in the end of the second eyelet 530.

The excess load applied to the ADSS cable 10 pulls the second eyelet 530 in the opposite direction (indicated by the right facing arrow A′ in FIG. 8) and, with the pawl 590 released from the detent 600, the shaft 534 of the second eyelet 530 slides rightwards away from the shaft 524 of the first eyelet 520. This in turn brings the ADSS cable 14 into engagement with the guillotine or knife 630 and, with the continued load in the rightward direction indicated by the arrow A′, causes the ADSS cable 14 to be cut.

Although a specific embodiment has been described, it will be appreciated that this is for the purposes of illustration only and is not intended to be limiting. Various alternatives will be appreciated by the skilled person. For example, firstly, although the anchors 15 described in connection with FIGS. 2 and 6 in particular, permit attachment to the support 7, this is not essential. Instead, the housing 18 could be affixed to the support 7, and the anchors 15 then attached to the housing 18 rather than the support. Indeed, in that case, it may not be necessary to provide one or more fused couplings (15b of FIG. 6). Instead, the manner of coupling to the housing, or indeed the construction of the housing itself, may be sufficient to provide a point of mechanical weakness in the coupling. In other words, when an abnormal load is applied to the ADSS cable 10, this could result in mechanical failure of the housing itself, thus releasing the ADSS cable 10 from its anchor point, bringing the loop of ADSS cable 14 into tension, and resulting in breakage of the ADSS cable at the region of mechanical weakness. Furthermore, a gland 19 could itself be designed with sufficient strength to allow coupling of the ADSS cable 10 and support of the tension in the cable between the housing and an adjacent support, so it is the gland 19 itself which mechanically fails upon application of an abnormal load to the ADSS cable feeding into it. Thus, the term “anchor” is to be understood in its broadest sense of a point, location or region which provides strain relief, during normal operation to the region of mechanical weakness formed within the ADSS cable on the other side of that anchor point.

Furthermore, although the specific embodiment described above employs a fused coupling 15b on one side of the support 7, and an unfused coupling 15a on the other side of that same support, it could of course be feasible to employ two fused couplings 15b instead, provided only that application of an abnormal load results in preferential breakage of the anchor so that, ultimately, the ADSS cable 10 breaks before the support 7 is pulled down. Such an arrangement might be needed if adjacent spans passed over critical crossings, for example if a pole were sited between two parallel and adjacent roads.

The pin 17 may take many forms, in order to provide additional assistance in breaking the ADSS cable at the region of weakness 16.

It is also to be understood that the formation of the ADSS cable 10 with a region of mechanical weakness is not an essential feature. The ADSS cable shown in FIG. 4 has two jackets 4, 6 with an aramid layer 5 sandwiched between them. The aramid layer 5 is fibrous and so cannot readily be snapped by flexing. Thus to allow breaking of the csm 1 of the ADSS cable 10, it is desirable to remove the outer layer 6 to access the aramid layer 5 so that the latter in particular can be removed to form a region of mechanical weakness. The csm 1 and fibre optic tubes 2 of the ADSS cable 10 in this arrangement remain, however, relatively robust and handleable.

FIG. 10 shows an alternative, simpler arrangement of ADSS cable 10′. Here, the central strength member 1 is surrounded by the fibre optic tubes 2 which are in turn wrapped in aramid 5. An outer sheath 6 then provides weather protection.

It will be appreciated that, when the aramid layer 5 and outer sheath 6 are removed from the ADSS cable 10′ of FIG. 10, the optical fibres are left exposed and unsupported, whereas in the arrangement of FIG. 4, the inner sheath 4 provides some further mechanical support.

The guillotine arrangement illustrated in FIGS. 8 and 9 provides a means by which the ADSS cable 10′ shown in FIG. 10 can be severed even without the removal of the outer aramid layer 5 and/or the outer protective layer 6.

The embodiments described are by no means mutually exclusive. For example, the arrangement of FIG. 9 is shown with a first housing portion 510a and a second housing portion 510b, with the guillotine/knife 630 in the second housing portion 510b. However the guillotine/knife 630 and indeed then the second housing portion 510b need not be present; the pawl/detent arrangement in the first housing portion 510a is operable without the cable cutting taking place in the same housing 510. For example, particularly but not exclusively if the ADSS cable is of the type shown in FIG. 4, and has the aramid layer 5 and outer sheath layer 6 removed to form a region of mechanical weakness, a simple pin or the like (such as the pin 17 of FIG. 3) can be positioned adjacent to that region of mechanical weakness, formed away from the mechanical fuse itself.

Likewise the guillotine/knife arrangement of FIGS. 8 and 9 can equally be employed in respect of the embodiment of FIG. 3 instead of the pin. Such an arrangement may be suitable for the modified form of ADSS cable 10′ shown in FIG. 10.

Finally, although the invention has been described in the context of an abnormal load caused by snagging of the ADSS cable 10 by a moving vehicle, it will of course be understood that this is merely exemplary. The line can be protected from any snagging hazard, for example if the line spans a river along which boats travel.

1. A mechanical fuse for an all dielectric self supporting (ADSS) telecommunications cable, comprising:
a continuous length of ADSS cable;
an anchor to support the continuous length of ADSS cable relative to a cable support, the anchor having a predetermined breaking strength; and
a means for deforming, kinking or severing the ADSS cable when a load in excess of the predetermined breaking strength of the anchor is applied thereto, so that the ADSS cable is caused to break at a breaking region.

2. A mechanical fuse according to claim 1, wherein the anchor comprises:
a first part, connected to the ADSS cable; and
a second part, connected to the cable support,
wherein the first and second parts are configured to connect together, and to separate when a load corresponding to the predetermined breaking strength is applied to the ADSS cable.

3. A mechanical fuse according to claim 2, wherein the first and second parts are reconnectable, such that the mechanical fuse is configured to be re-usable.

4. A mechanical fuse according to claim 2, wherein the anchor comprises a spring configured to provide the predetermined breaking strength.

5. A mechanical fuse according to claim 4, comprising:
a pawl configured to connect the first part to the second part, the spring being provided to resist separation of the pawl from the one of the first and second parts.

6. A mechanical fuse according to claim 1, wherein the breaking region of the ADSS cable is a region of mechanical weakness formed therein; and the ADSS cable is caused to break at that region of mechanical weakness.

7. The mechanical fuse of claim 1, wherein the means for deforming, kinking or severing the ADSS cable comprises a severing member positioned relative to the ADSS cable so as, in use, to engage the breaking region of the ADSS cable when the load in excess of the predetermined breaking strength is applied to the anchor.

8. A mechanical fuse according to claim 7, wherein the anchor comprises:
a first part, connected to the ADSS cable; and
a second part, connected to the cable support,
wherein the first and second parts are configured to connect together, and to separate when a load corresponding to the predetermined breaking strength is applied to the ADSS cable; and
wherein the breaking region of the ADSS cable is attached to one of the first or second parts of the anchor; and
the severing member is connected to the other part,
the severing member configured to sever the ADSS cable in the breaking region when the first and second parts of the anchor are separated.

9. The mechanical fuse of claim 1, further comprising a housing enclosing the breaking region.

10. The mechanical fuse of claim 9, wherein the housing is weatherproof and further comprises first and second weatherproof seals through which the continuous length of ADSS cable enters and exits the housing, respectively.

11. The mechanical fuse of claim 1, wherein the ADSS cable is formed within an inner fibre optic core and at least one mechanically supportive outer cladding layer, and wherein the breaking region comprises a region of the ADSS cable from which at least a part of the outer cladding layer has been removed.

12. An overhead power line support, in combination with the mechanical fuse of claim 1.

13. The combination of claim 12, wherein the anchor is a first anchor affixed between the support and the ADSS cable on a first side of the breaking region thereof, the combination further comprising a second anchor affixed between the support and the ADSS cable on a second side of the said breaking region, such that, in use, a length of the ADSS cable including the breaking region is located between the first and second anchors.

14. The combination of claim 13, further comprising a housing enclosing the breaking region, wherein the housing of the mechanical fuse is mounted upon the overhead power line support, and wherein the continuous length of ADSS cable is connected to the overhead power line support via the first and second anchors so that a portion of the continuous length of ADSS cable including the region of mechanical weakness is supported between a first side of the first and second anchors at a first tension, which is lower than the tension in the continuous length of ADSS cable on a second side of the first and second anchors.

15. The combination of claim 12, wherein the first anchor is configured or constructed to break when the said load in excess of the predetermined breaking strength is applied to the continuous length of ADSS cable.

16. A mechanical fuse for an all dielectric self supporting (ADSS) telecommunications cable comprising:
an ADSS cable comprising a first section and a second section, wherein at least a portion of the second section has a region of weakness; and
a frangible connector configured to break when a load in excess of a predetermined amount is applied to it;
and wherein the frangible connector is configured:
to connect the ADSS cable to an anchor point directly or indirectly supported by an overhead power supply support, such that the tension in the first section of the ADSS cable is supported, and the second section of the ADSS cable is at least partially relieved of tension; and
to cause the second section of the ADSS cable to come under increased tension when the frangible connector breaks;
and wherein the region of weakness of the second section of the ADSS cable is configured to break when the second section of the ADSS cable comes under increased tension.

17. The mechanical fuse of claim 16, wherein the ADSS cable comprises an inner fibre optic core and one or more outer strengthening layers, and wherein:
the region of weakness comprises a portion of the ADSS from which the, or at least one of the outer strengthening layers has been removed.

18. The mechanical fuse of claim 16, wherein the ADSS cable comprises an inner fibre optic core and one or more outer strengthening layers, and wherein:
the region of weakness comprises a slit in one, or at least one of, the outer strengthening layers of the ADSS.

19. The mechanical fuse of claim 16, further comprising:
a severing member, positioned adjacent to the region of weakness, so that, when the second section comes under increased tension, the region of weakness is urged against the severing member so as to sever the inner fibre optic core of the ADSS cable.

20. The mechanical fuse of claim 16, further comprising:
a housing, which encloses the region of weakness of the second section of the ADSS cable.

21. A method of attaching an all dielectric self supporting (ADSS) telecommunications cable to a support, comprising:
(a) attaching the ADSS cable to an anchor point directly or indirectly supported by the support, so as to support the tension in a first section of the ADSS cable, on a first side of the anchor point, the ADSS cable being attached to the anchor point via a separable connection; and
(b) forming a breaking region in the ADSS cable, in a second section thereof, which is on a second side of the anchor point, the second section of the ADSS cable being at least partially relieved of tension;
wherein application of a load in excess of a predetermined amount results in separation of the separable connection, so that the second section then comes under increased tension which results in breakage of the ADSS cable at the breaking region.

22. The method of claim 21, further comprising applying a load in excess of said predetermined amount so as to cause the ADSS cable to break at the breaking region.

23. The method of claim 22, wherein the ADSS cable has an inner fibre optic core and one or more outer strengthening layers, the method further comprising forming the breaking region in the ADSS cable by removing the or each of the outer strengthening layers to form a region of weakness.

24. The method of claim 22, wherein the ADSS cable has an inner fibre optic core and one or more outer strengthening layers, the method further comprising forming the breaking region in the telecommunications cable by slitting the or each of the outer strengthening layers to form a region of weakness

25. The method of claim 21, further comprising:
positioning a severing member adjacent to the breaking region so that when the second section comes under increased tension the region of weakness is urged against the severing member so that the ADSS cable is severed at that location.

26. The method of claim 21, further comprising:
enclosing at least the breaking region of the second section of the telecommunications cable in a weatherproof housing.
